(19) United States
(12) Patent Application Publication
(10) Pub. No.: US 2025/0388105 A1
(43) Pub. Date: Dec. 25, 2025

(54) METHOD AND SYSTEM FOR CONTROLLING THE MATING IN A SYSTEM FOR THE AUTONOMOUS CHARGING OF ELECTRIC VEHICLES

(71) Applicant: Rocsys B.V., Rijswijk (NL)

(72) Inventors: Kanter van Deurzen, Delft (NL); Johannes Oosten van der Weijde, Delft (NL)

(21) Appl. No.: 19/236,901

(22) Filed: Jun. 12, 2025

(30) Foreign Application Priority Data
Jun. 19, 2024 (NL) 2037994

(51) Int. Cl. B60L 53/37; B60L 53/16; B60L 53/30; B60L 53/66

(52) U.S. Cl. CPC B60L 53/37; B60L 53/16; B60L 53/305; B60L 53/66

(57) ABSTRACT

A method for controlling an autonomous charging device (ACD) configured to manipulate an electric vehicle charging connector for mating into a vehicle inlet, the vehicle charging connector and the vehicle inlet configured to transition between at least an unmated state, a partially mated state and a fully mated state. The partially mated state comprises a partial insertion of the charging connector into a cavity of the vehicle inlet and the fully mated state comprises a state wherein a transfer of energy is allowed. The method comprises, using a controller, (a) manipulating the charging connector towards the vehicle inlet and determining, whether the charging connector and the vehicle inlet have reached the partially mated state; and (b) if the determination indicates that the charging connector and the vehicle inlet are in the partially mated state, manipulating the charging connector to move to the fully mated state.

### CROSS-REFERENCE TO RELATED APPLICATION

The present application claims priority from pending Netherlands Patent Application No. 2037994, filed Jun. 19, 2024, which is incorporated herein by reference.

### TECHNICAL FIELD

The present invention relates to the field of autonomous charging systems for electric vehicles. Specifically, it pertains to methods, systems, and computer programs for optimizing the operation of autonomous charging devices, often referred to as ACD's, by efficiently manipulating a vehicle charging connector.

### BACKGROUND

The surge in electric vehicle (EV) adoption has propelled a substantial demand for autonomous charging solutions, often referred to as autonomous charging systems or devices. Traditional approaches to vehicle charging often involve manual intervention, requiring drivers to physically connect charging cables to their vehicles.

Autonomous charging systems typically feature actuated robotic systems, mechanisms to support and manipulate a charging connector, and computer vision technologies. Such technologies, often supported by neural networks and algorithms, enable the system to recognize the vehicle's charging inlet and facilitate the connection and disconnection of the charger to the vehicle inlet. Devices and related methods for this purpose are known in the state of the art, for instance from the international patent applications WO2020222640, WO2021167462, WO2022005281, WO2022045881, WO2022086320, WO2022234059, WO2023131577, WO2023227412, WO2024068806, WO2024133162A1, WO2023198456, NL2035240, NL2035932, NL2036719, all from the same applicant, all of which are herein incorporated by reference.

However, as the automotive industry progresses towards autonomy, the need for automated charging solutions capable of efficiently and accurately executing the mating between the charging connector and the vehicle inlet becomes increasingly evident. Failure to meet this need can lead to prolonged charging times, safety risks, heightened downtime for vehicle owners, and a suboptimal user experience. This technical challenge arises from various factors, including the complexity of ensuring a reliable, fast and secure physical connection between the charging connector and the vehicle inlet without human intervention. Without a reliable automated solution, there is a risk of prolonged charging times, safety hazards due to potential incomplete connections or misalignments, increased vehicle downtime, and overall dissatisfaction among electric vehicle users.

The present invention addresses these challenges.

### SUMMARY

An object of the invention is to provide a method and a system for controlling the mating in a system for the autonomous charging of electric vehicles.

According to a first aspect of the invention, the object is achieved by a method according to claim 1.

According to the first aspect of the invention, there is provided a method for controlling an ACD configured to manipulate an electric vehicle charging connector for mating into a vehicle inlet, the vehicle charging connector and the vehicle inlet configured to transition between at least an unmated state, a partially mated state and a fully mated state, wherein the partially mated state comprises a partial insertion of the charging connector into a cavity of the vehicle inlet and wherein the fully mated state comprises a state wherein a transfer of energy is allowed, the method comprising, by a controller, at least the following steps: (a) manipulating the charging connector towards the vehicle inlet and determining, whether the charging connector and the vehicle inlet have reached the partially mated state; and (b) if the determination indicates that the charging connector and the vehicle inlet are in the partially mated state, manipulating the charging connector to move to the fully mated state.

Determination of a partial mating is beneficial as it allows for early detection of misalignment or potential mating issues before full engagement. Determination of a partial mating may ensure that the charging process proceeds efficiently and safely. If a partial mating is successful, the charging device may proceed to fully mate the charging connector with the vehicle inlet, for example, by applying a different force pattern or a higher counteracting force with a certainty that no risk, or low risk, of clamping with excessive force or entrapment exists once the connector is partially mated. On the other hand, if partial mating is unsuccessful, corrective actions can be taken, such as adjusting the position of the charging connector or reattempting alignment. This step may enable reducing the risk of damage to the charging connector or vehicle inlet and minimizes safety hazards, including the risk of human entrapment or clamping of body parts with excessive force.

Determination of a partial mating implies an additional and, at times, decisive step in the mating process. In conventional systems known in the state of the art, a partial mating inherently occurs as an intermediate phase prior to achieving full mating; however, it is typically not recognized or utilized as a distinct operational state. The present invention, by contrast, focuses on the identification and deliberate realization of the partially mated state as a discrete condition within the control logic of the ACD. By treating the partially mated state as a verified transition state, the system enables the application of tailored control strategies such as adaptive force profiles and alignment corrections, which are typically absent from conventional control approaches.

Example and additional embodiments are described in the dependent claims.

In a second embodiment, the present invention provides for a system for controlling an autonomous charging device (ACD) as defined in one of the independent claims.

In a third embodiment, the present invention provides for an ACD as defined in one of the independent claims.

In a fourth embodiment, there is provided a computer program comprising program code means for performing the steps of the first aspect when the program is run on a computer.

In a fifth embodiment, there is provided readable medium carrying a computer program comprising program code means for performing the steps of the first aspect when the program product is run on a computer.

Further features of, and advantages will become apparent when studying the appended claims and the following description. The skilled person will realize that different features may be combined to create embodiments other than those described in the following, without departing from the scope of the present disclosure.

### BRIEF DESCRIPTION OF THE DRAWINGS

FIG. 1 is a schematic diagram of an ACD according with one embodiment of the present disclosure.

FIG. 2 is a simplified structural block diagram of an ACD according to an embodiment of the disclosure.

FIGS. 3a and 3B show representations of a vehicle charging connector and a vehicle charging inlet, respectively.

FIGS. 4A and 4B show two representations of a partially mated state.

FIGS. 5A and 5B show representations of a manner for describing an unmated state and a mated state

FIGS. 6A and 6B shows representations of a vehicle charging connector and charging inlet where a locking device is depicted.

FIG. 7 is a flowchart illustrating a method for controlling an ACD according to an embodiment of the present disclosure.

FIG. 8 shows a simplified structural block diagram of a computing environment.

### DETAILED DESCRIPTION

Some existing systems have various shortcomings relative to certain applications. Accordingly, there remains a need for further contributions in this area of technology. International Patent Application WO2023116667 describes a charging device comprising: a control structure, and a mechanical arm main body, which is provided with a force sensor and a charging plug, wherein the force sensor is used for collecting acting force information between a side face of a charging head and a charging port after the charging plug makes contact with the charging port; and the control structure can control the pose of the mechanical arm main body according to the acting force information, so as to insert the charging plug into the charging port. This document mainly relies on information obtained by force sensors to adjust for the mating of the connector into the vehicle inlet.

The present invention is described below with reference to flowchart descriptions of the method, system, and apparatus, or to block diagrams. Each block or combination of blocks in these diagrams may be implemented by computer program instructions or corresponding hardware. When implemented via software, such instructions may be executed on a general-purpose computer, a special-purpose computer, an embedded processor, or another programmable data processing device to form a machine that performs the specified function or operation.

These computer program instructions may also be stored in a computer-readable memory to configure the computer or other programmable device to operate in a particular manner, such that the instructions stored in memory cause the device to perform the specified functions or operations in the flowcharts or block diagrams.

Additionally, the instructions may be loaded onto a computer or programmable processor to execute a sequence of steps that result in computer-implemented processing. Accordingly, the instructions enable implementation of the functions or operations described in the diagrams. In some embodiments, the order of the blocks may vary, with certain steps performed concurrently or in reverse order, depending on the specific functions involved.

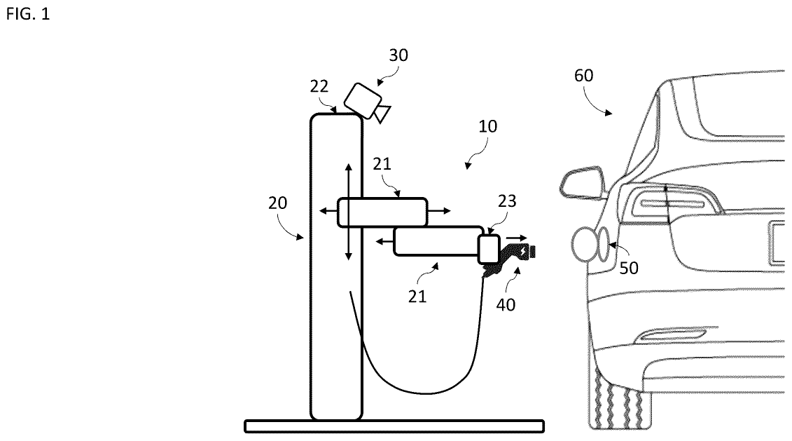

An ACD 10 according to an implementation of the present disclosure will be described below in conjunction with FIG. 1.

FIG. 1 is a diagram illustrating an ACD 10 for the autonomous connection of a vehicle charging connector 40 into a vehicle inlet 50 according to one embodiment of the present disclosure. In the context of the disclosure, the term “vehicle” or other similar terms is intended to mean a pure electric vehicle or a hybrid vehicle powered at least in part by a power battery. A hybrid vehicle is a vehicle with two or more power sources, such as a vehicle powered by a gasoline engine and an electric motor.

In reference to FIG. 1, a device 10 comprises a robotic system including a robotic arm 20 adapted to support a charging connector 40. The robotic arm 20, comprises one or more moveable sections 21 which enable the charging connector 40 to be translatable or rotatable along or around an axis in at least one to six degrees of freedom. An end-effector 23 can be positioned between a moveable section 21 and the charging connector 40. The end effector 23 may be a controllable actuated mechanism comprising means to support, either in a releasable manner or not, the vehicle charger connector 40. In the present disclosure, the term “robot” or “robotic” may, but not necessarily must, conform to the traditional industry standards definition of a complete autonomous robot with sensory perception, decision-making capabilities, and mobility. Instead, in the context of the present disclosure, the term “robot” primarily refers to a controlled actuated mechanism or arm designed for specific tasks, such as the ones in accordance with the present invention. The term “robot” emphasizes the mechanized and programmable nature of the system rather than the strict dependance on a fully autonomous robot with general-purpose capabilities.

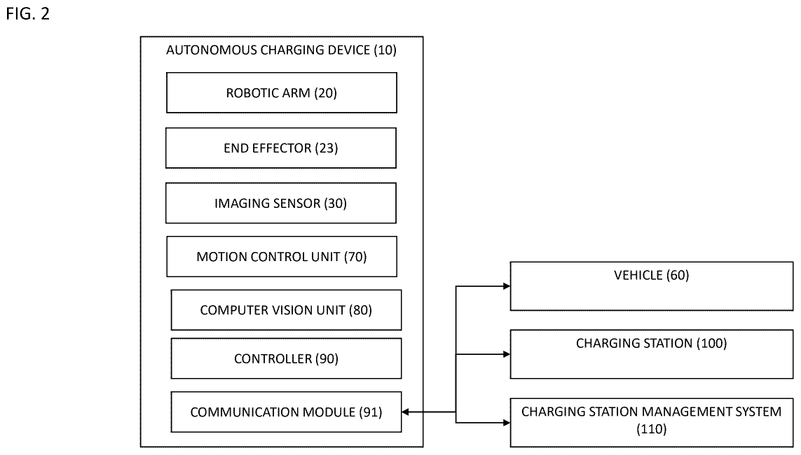

FIG. 2 is a simplified structural block diagram of an ACD 10 according to an embodiment of the disclosure. In reference to FIG. 2, the ACD 10 further comprises, or is in communication with a motion control unit 70 which is configured to control the motion of the device 10 or a component thereof, such as the robotic arm 20 or the end effector 23 for, among others, mating the connector 40 into the vehicle inlet 50. The ACD 10 is set to support and manipulate the charging connector 40 in at least one, two, three, four, five or six degrees of freedom. In further reference to FIG. 1, when an electric vehicle 60 is to initiate a charging cycle, and after the vehicle is positioned in its vicinity, the device 10 is configured to determine a pose of the vehicle charging inlet 50, and at least based on that pose determination, manipulate the charging connector 40 towards the inlet 50 and mating the charging connector 40 into the vehicle inlet 50.

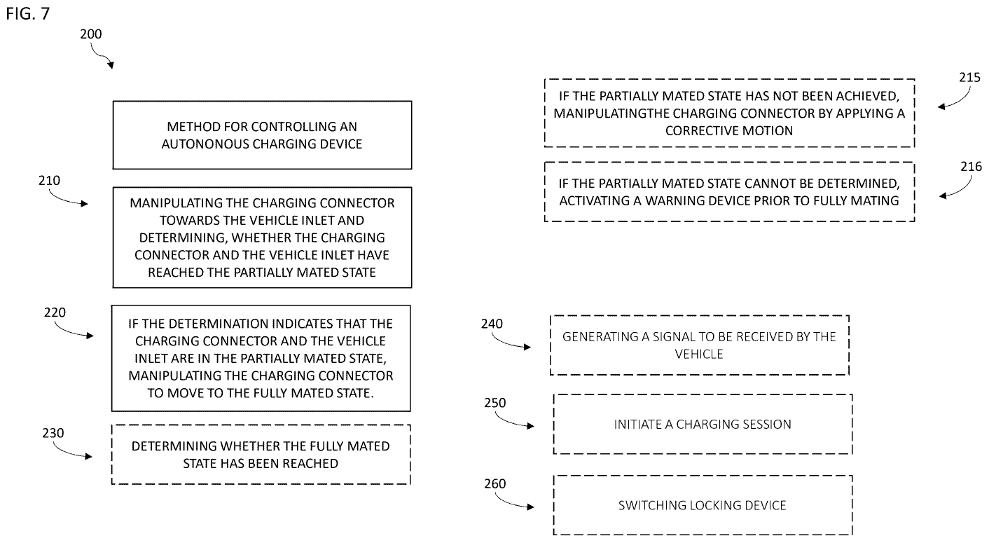

In reference to FIG. 2, the ACD 10 further comprises, or is in communication with a controller 90 which is configured to execute instructions in accordance with one or more of systems, flowcharts, methods, and/or processes described herein. The controller comprises, or is in communication with a computing environment as depicted in FIG. 7.

In reference to FIG. 1 or FIG. 2, the device comprises, or is in communication with, an imaging sensor, such as camera 30. In reference to FIG. 1, the camera 30 is fixed to a supporting surface 22 of the device 10 and can remain stationary relative to the motions of the robotic arm 20, the end effector 23, or the charging connector 40. Thereby, the camera 30 position remains substantially unchanged when the charging connector 40 is manipulated by the robotic arm 20. In some embodiments (not shown), the camera is fixed to a moveable section of the robot 21 or to the end effector 23. Thereby, the camera can be coupled to the movement moveable section 21, the end effector 23 or the charging connector 40. A controller 90 is configured to coordinate the processing of information, such as sensor information and to coordinate the motion and operation of the device 10 or any component thereof.

In reference to FIG. 2, the ACD comprises, or is in communication with, a computer vision unit 80 configured to determine a pose of the vehicle inlet 50 utilizing one or more images captured by the camera 30. In some embodiments, the ACD 10, by means of the computer vision unit 80, is configured to determine the pose of the vehicle inlet 50 by utilizing recognizable features visible in an image captured by the camera 30. The computer vision unit is preferably provided with a suitable neural network trained to determine the pose of an object through an analysis of one or more images. Recognizable features comprise features of the vehicle charging inlet, such as the inlet pins, inlet holes, inlet housing, inlet cover, inlet locking mechanisms and combinations thereof. Other recognizable features comprise a referential marker, such as a QR code, whose position or relative position to the vehicle inlet is known. As used in the present disclosure, the term “pose” refers to a spatial orientation in a three, four-, five-, or six-dimensional space of an object. Additionally, or alternatively, the pose may involve dimensions of information representing the object's position relative to the camera.

In reference to FIG. 2, in some embodiments, the ACD 10 is configured to determine the pose of the vehicle charging inlet 50 by receiving information about the pose of inlet 50, wherein such information is received from the vehicle 60, from a charging station 100 or from a charging station management system 110. Such information is transmitted through a communications module 91. Such information about the pose of the inlet 50 comprises at least one of accurate pose coordinates, estimated pose coordinates, and expected pose coordinates, in each case at any time or at a predetermined time.

In reference to FIG. 2, the ACD 10 comprises a communication module 91, a memory (not shown), and a processor (not shown). The communication module 91 is configured to communicate with an external apparatus, for example, to receive state data about the vehicle 60, either from the vehicle 60, from a charging station 100, from a charging station management system 110, from a cloud service (not shown), from a remote management system (not shown) or from a combination thereof.

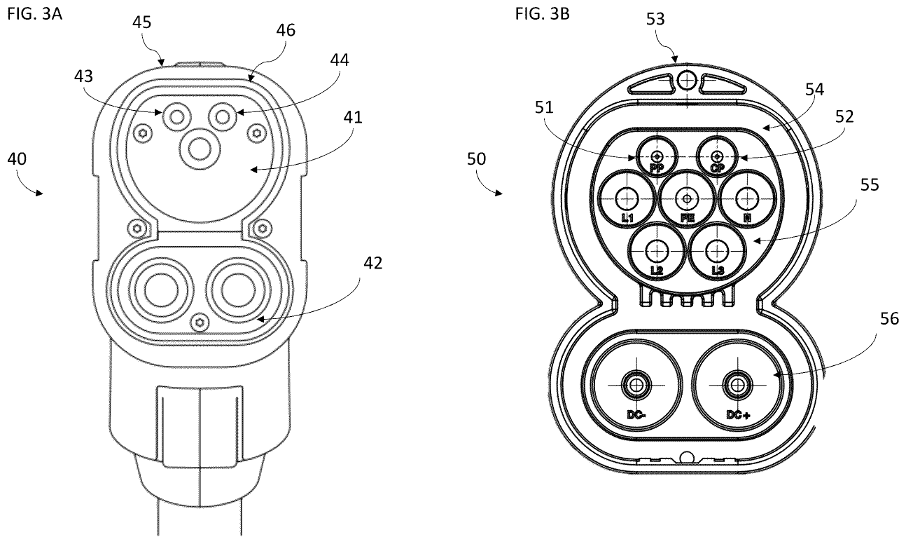

In reference to FIG. 3A and FIG. 3B, a charging connector 40 and a vehicle inlet 50, respectively, in accordance with one embodiment of the disclosure are depicted.

A charging connector may be any type typically used for charging an electric vehicle, including but not limited to Type 1, Type 2, CCS-1, CCS-2, CHAdeMO, Tesla, NACS, and MCS connectors. Referring to FIG. 3A, the charging connector 40 comprises a housing 45, and an insulating and guiding body 46. The charging connector 40 and charging inlet 50 includes an AC connector section 41, 55, respectively, arranged at the top section and a DC connector section 42, 56, respectively, arranged at the bottom section, each with a plurality of plug contacts 43, 44 that correspond to a plurality of connectors 51, 52 in FIG. 3B and are adapted to connect with each other. In reference to FIG. 3B, the vehicle charging inlet 50 comprises a housing 53 and an insulating and guiding body 54. In these non limiting examples, pins 43 and 52 correspond to the control pilot and pins 44 and 51 correspond to the proximity pins.

It is to be understood that the number and arrangement of the plug contacts (or pins) illustrated in FIG. 3A and FIG. 3B are only used as example for explaining the principles of the present disclosure, rather than to limit the scope of the present disclosure. A charging connector according to one implementation of the present disclosure is configured to charge an electric vehicle using only AC current, or combination of AC and DC current, as depicted in FIG. 3A and FIG. 3B. The plurality of pins may include at least one of a signal pin, an AC line pin, a neutral pin, a control pilot pin, a proximity detection pin, a ground pin. The plurality of pins may also include a DC positive pin and a DC negative pin.

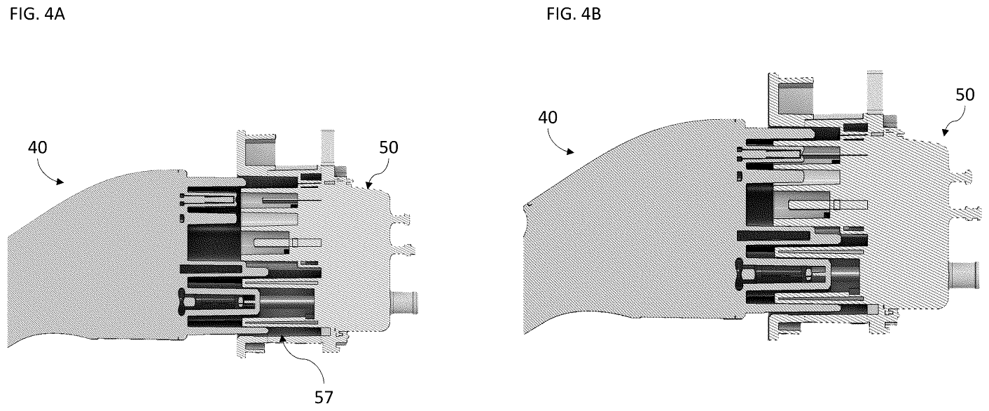

In reference to FIG. 4A and FIG. 4B, an exemplary and not limiting depiction of a partially mated state between the charging connector 40 and the vehicle inlet 50 is depicted. A partially mated state may comprise a partial insertion of the charging connector into a cavity 57 of the vehicle inlet, as depicted in FIG. 4A. In some cases, a partially mated state comprises the (initial) establishment of a connection or communication between a charging connector pin and a vehicle inlet pin even when the connector is not fully mated into the vehicle inlet, as depicted in FIG. 4B. Such connection or communication may comprise a detection signal from the pilot pin or the proximity pin. In some cases, a partial mating between the charging connector and the EV inlet comprises the absence of a discernible gap between the charging connector and the EV inlet.

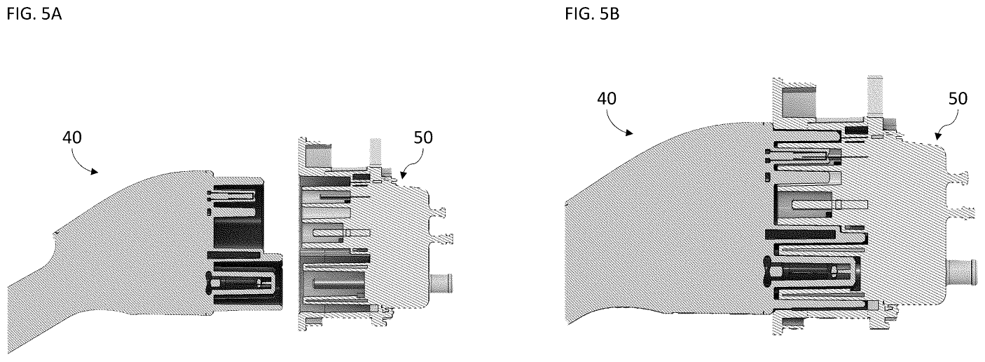

In reference to FIG. 5A, an exemplary and not limiting depiction of an unmated state is provided. In reference to FIG. 5B, an exemplary and not limiting depiction of a fully mated state is provided, wherein the charging connector 40 is mechanically engaged with the vehicle inlet 50 and wherein the energy transfer can be initiated wherein the pins are in connection or communication.

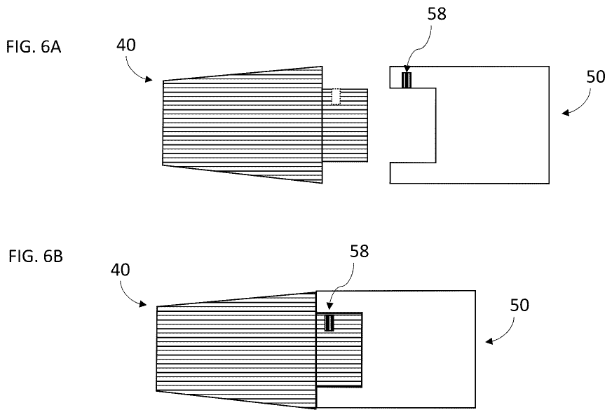

In reference to FIG. 6A and FIG. 6B, the vehicle charging inlet 50 comprises a locking device 58 configured to securely hold the charging connector 40 in place during the energy transfer. The locking device 58 is configured to be switchable between a locked state in which the connector connected to the inlet cannot be removed from the inlet (FIG. 6B), and a non-locked state in which the connector connected to the inlet can be detached from the inlet (FIG. 6A), thereby ensuring an electrical connection between the charging connector and the vehicle charging inlet.

When used herein a partial mating comprises a state wherein a transfer of energy for the charging of the vehicle is not allowed or cannot be initiated, even when a contact may take place between a charging connector pin and an inlet pin. A partial mating does not comprise a full mating.

A method 200 for controlling an ACD configured to manipulate an electric vehicle charging connector 40 for mating into a vehicle inlet 50, will be described below in conjunction with anyone of FIG. 1 to FIG. 6B. In FIG. 7, blocks in dashed lines comprise optional steps. The method can be implemented as an algorithm that can be executed by a controller 90.

When used herein, mating and unmating comprise the processes of connecting and disconnecting, respectively, the charging connector 40 with or from the vehicle charging inlet 50. Mating comprises the alignment and engagement of the charging connector with the vehicle inlet for the transfer of electrical energy during the charging cycle. Unmating comprises the disengagement and disconnection of the charging connector 40 from the vehicle charging inlet 50 once the charging cycle is complete.

As shown in FIG. 7, the method 200 comprises, by a controller: a step 210 comprising manipulating the charging connector towards the vehicle inlet and determining, whether the charging connector and the vehicle inlet have reached the partially mated state. The vehicle charging connector, with respect to the vehicle inlet is configured to transition between at least an unmated state, a partially mated state and a fully mated state, wherein the partially mated state comprises a partial insertion of the charging connector into a cavity of the vehicle inlet and wherein the fully mated state comprises a state wherein a transfer of energy is allowed. Transition between different states may take place in any order, such as from unmated state to partially mated state and to fully mated state; but also from partially mated to unmated and from fully mated to partially mated.

Recognizing the partially mated state as a verified transition state allows the system to confirm alignment and identify potential issues before proceeding to full mating. This improves the reliability and safety of the charging process. When partial mating is successfully detected, the system can proceed to full mating with sufficient confidence, for example by applying a higher counteracting force, while minimizing risks such as misalignment, excessive clamping, or entrapment. If partial mating is not achieved, corrective actions can be taken, such as repositioning the connector or reattempting alignment, thereby reducing the likelihood of damage to the connector or vehicle inlet. In some cases, however, it may not be possible to detect the partially mated state due to limitations in sensor input or environmental conditions. In such cases, the system can be configured to proceed with full mating based on fallback strategies, which may include activating warning signals, applying conservative force limits, or initiating additional verification steps.

In step 210, determining whether the charging connector and the vehicle inlet have reached the partially mated state, may be accomplished through several means. Determination of the partially mated state can be made before, during or after the charging connector has been manipulated to a position where the ACD anticipates the vehicle inlet to be located. Such anticipation of the vehicle inlet, by the ACD, may be accomplished via several means, including but not limited to utilizing, or receiving information from computer vision means, force sensors data, lidar sensors, proximity sensors, the vehicle, a charger, the connector, a management system, or a combination thereof. The ACD 10 may utilize or receive information about the vehicle inlet and its surrounding features. Moreover, the ACD 10 may utilize machine learning algorithms to predict an expected position of the charging inlet based on historical data and patterns of vehicle behavior or utilizing a combination of sources of information as described herein. The ACD 10 may also receive information regarding the vehicle inlet position from the vehicle, either directly from the vehicle, from a charging station, or from a charging station management system using suitable communication means, such as pairing and positioning means.

In some embodiments, the step of determining whether the partially mated state has been reached comprises detecting a predefined condition that characterizes partial mating. This predefined condition may correspond to a specific measurable event or signal that reflects a partial insertion of the charging connector into the vehicle inlet, without requiring full mechanical engagement or energy transfer capability. Such a condition may include, for example, the detection of initial contact between designated pins, the alignment of geometric features within a defined tolerance, or the presence of a signal within an expected range

For example, determining whether the charging connector and the vehicle inlet have reached the partially mated state may be accomplished by determining a connection state between the charging connector 40 and the vehicle inlet 50. Where the charging connector 40 comprises one or more power pins, communication pins, or proximity pins, determination of a connection state between the charging connector 40 and the vehicle inlet 50 may be made by receiving information comprising the existence and/or quality of the connection or communication between a pin and counter pin, in particular a detection signal of such pin and counter pin, wherein such information is received from at least one of the charging connector, the vehicle, a charger, a charging station management system, or a vehicle management system. In some embodiments, determining a connection state is based on a detection signal threshold. Thereby, the controller can evaluate the received detection signal against a predefined threshold to ascertain a reliability of the connection state between the charging connector and the vehicle inlet. If the detection signal surpasses such designated threshold, indicating a reliable connection state, the controller determines that the partially mated state has been achieved.

Determination using a connection state is advantageous due to its ability to provide an objective or quantifiable basis for identifying the partially mated state. By relying on measurable signals, such as those generated by proximity, control, or communication pins, the system can reduce dependence on visual or force-based detection methods, which may be less reliable under varying environmental conditions. In some cases, the signal is received by the ACD from the connector or charger, such as a voltage or current reading across a proximity pin, a signal level from a control pilot circuit, or a handshake message indicating initial communication between the vehicle and the charging system. Determination using a connection state is also advantageous because it implies not only that the connector is partially mated, but also that it is in a suitable position to transition into full mating.

Determination of a connection state between the charging connector 40 and the vehicle inlet 50 can be made by receiving information about the vehicle, such information comprising a signal indicating that a partial mating is successful. Such indication can be any type of information which can represent the partially mated state. For example, the indication may include: an electric signal indicating the presence or absence of an electrical signal detected by the charging connector's pins when they make initial contact with the vehicle inlet; a communication signal including data received from the vehicle's onboard systems indicating that the connector has made partial contact; a sensor in, on, or near the vehicle inlet equipped to detect the presence of a connector, or a sensor on, in or near the connector equipped to detect the presence of a vehicle inlet, using sensors including but not limited to switches, light gates, and proximity sensors.

In some embodiments, determining whether the charging connector and the vehicle inlet have reached the partially mated state may be accomplished by receiving a sensor signal from a sensor in communication with the ACD, wherein such sensor signal includes at least one of a camera sensor, a proximity sensor and a force sensor. Thereby, the ACD can use these sensor signals to determine a partial mating of the charging connector with the vehicle inlet. For example, a camera sensor can provide visual confirmation of the partial alignment, while a proximity sensor can detect the distance and relative positioning of the charging connector to the vehicle inlet. Additionally, or alternatively, a force sensor can measure the contact force between the connector and the inlet, ensuring it is within an acceptable range for partial mating.

In reference to FIG. 7, if the determination indicates that the charging connector and the vehicle inlet are in the partially mated state, the method 220 proceeds to manipulating the charging connector to move towards the fully mated state. Fully mating can be achieved by aligning the charging connector with the vehicle inlet and applying a force to ensure a complete connection. Fully mating also includes carrying out corrections such as repositioning of the charging connector, adjusting a mating angle, adjusting a mating force, engaging mechanical locking mechanisms, and combinations thereof.

In some embodiments, the controller is configured to apply a different force pattern when the connector and the vehicle inlet are in the partially mated state than when the connector and the vehicle inlet are in the unmated state. In some cases, the controller is configured to manipulate the charging connector by applying a counteracting force (f1) higher than a counteracting force limit (f2) applied prior to the partial mating when transitioning from the partially mated state to the fully mated state, wherein a ratio of the counteracting force (f1) to the counteracting force (f2) limit is about 6:1, or about 4:1, or about 2:1. Thereby, a higher counteracting force (f2) is applied with confidence that the connector has been positioned correctly, reducing the risk of misalignment or damage.

While transitioning from the partially mated state to a fully mated state, the method comprises applying a force reduction strategy. A force reduction strategy comprises at least one of adjusting the applied force to the charging connector during the mating process, monitoring sensor feedback to detect any signs of resistance or misalignment, activating passive or active compliance mechanisms to compensate for misalignments or inaccuracies. If any anomalies are detected, such as unexpected resistance or misalignment, the force application can be adjusted or paused, allowing for corrective actions to be taken

On the other hand, if the determination indicates that the partial mated state has not been reached, the method comprises a step 215 comprising manipulating the charging connector by applying a corrective motion. Such corrective motion includes at least one of a vibrating motion, adjusting a positioning angle, and retracting the charging connector and reattempting the partial mating.

In some cases, it may not be feasible to determine if the partially mated state has been reached, for example, to due to environmental conditions affecting sensor accuracy, due to obscured views of the vehicle inlet, or errors or absence in communication charging connector pin signals, or a combination thereof. In such a case, the method further comprises a step 216 comprising activating a warning device, in particular an audible warning device or a visual warning device, prior to manipulating the charging connector to move to the fully mated state. In some embodiments, this activation and subsequent manipulation are carried out only when the autonomous charging device has previously performed a visual pose determination of the vehicle inlet, and the pose has been established with at least a predetermined minimum level of confidence. The predetermined confidence level is a threshold parameter stored in the controller, indicating that the pose estimation is sufficiently reliable for safe continuation of the mating process even in the absence of confirmation of the partially mated state.

When it is not feasible to determine whether the partially mated state has been reached, the system may rely on predefined fallback procedures to ensure continued operation while minimizing risks. For example, the controller may apply a reduced and controlled insertion force during the transition to full mating to avoid potential damage or misalignment. The system may perform incremental movements of the charging connector, combined with sensor feedback analysis, to assess indirect signs of connector engagement. If any irregularities such as resistance spikes or unexpected force patterns are detected, the system may pause the mating attempt and initiate a re-alignment routine.

Additionally, the system may adapt its behavior by activating safety protocols when partial mating cannot be verified. These protocols may include extending the use of proximity sensors to monitor surrounding objects, logging the event for diagnostic review, and transmitting a status signal to the vehicle or a central management system indicating that the mating process is proceeding under uncertainty. In such cases, the initiation of the charging session may be delayed or conditioned upon further validation, such as receiving an acknowledgment from the vehicle indicating successful connector engagement or detecting electrical continuity through low-voltage test pulses prior to full power transfer.

In reference to FIG. 7, the method optionally comprises, after manipulating the charging connector to fully mate into the vehicle inlet, a step 230 comprising determining whether the fully mated state is reached. Thereby, the controller may ascertain if the charging connector is securely engaged with the vehicle inlet. Step 230 determining, whether the fully mated state is reached, may be accomplished through several means. In some cases, determining the fully mated state comprises receiving information about a vehicle inlet or charging connector locking device, wherein such locking device is configured to be switchable between a locked state in which the connector connected to the inlet cannot be removed from the inlet, and a non-locked state in which the connector connected to the inlet can be detached from the inlet. FIG. 6 depicts a charging connector comprising a locking device, such as a latching device 58, which is configured to be switchable between a locked state in which the connector connected to the inlet cannot be removed from the inlet, and a non-locked state in which the connector connected to the inlet can be detached from the inlet. In such case, information about a vehicle inlet or charging connector locking device can be received from the vehicle 50, from the charging station 100 or from the charging station management system 110 or via any other suitable means.

In some cases, determining whether the fully mated state is reached comprises receiving a sensor signal from a sensor in communication with the ACD, wherein such sensor signal includes at least one of a camera sensor, a proximity sensor and a force sensor. Conversely, if the determination indicates that the fully mated state is not reached, the method comprises manipulating the charging connector by applying a corrective motion, wherein such corrective motion comprises at least one of a vibrating motion, adjusting a positioning angle, and retracting the charging connector and reattempting the full mating.

In some cases, determining whether the fully mated state is reached comprises receiving a signal about the vehicle indicating that the energy transfer has initiated after the mating of the charging connector into the vehicle inlet.

Optionally, the method 200 further comprises method step 240 comprises generating a signal to be received by the vehicle, the signal comprising an instruction to switch the inlet locking device from a non-locked state to a locked state after the full mating of the charging connector into the vehicle is completed

Optionally, the method 200 further comprises method step 250 comprising allowing, or instructing, at least one of a the charger device, the vehicle or the charging management system to initiate a charging session including the energy transfer.

Optionally, the method 200 further comprises method step 260 comprises providing a communication to be received by the vehicle, the communication comprising an instruction to switch the inlet locking device from a non-locked state to a locked state after the full mating of the charging connector into the EV is completed.

In some embodiments, if the determination indicates that the full mating is not successful, manipulating the charging connector by applying a corrective motion, wherein such corrective motion comprises at least one of a vibrating motion, adjusting a positioning angle, and retracting the charging connector and reattempting the full mating.

In an exemplary embodiment, the ACD 10 comprises a camera, approaches the vehicle charging inlet 50. The controller 90 processes a camera image to estimate the pose of the inlet 50. Upon manipulating the charging connector to reach proximity to the estimated pose, the controller acquires information to determine whether the charging connector 40 and the vehicle inlet 50 have reached a partially mated state. In this exemplary embodiment, the determination is made by receiving a signal from the charging connector and charging inlet proximity sensors. Once the controller 90 confirms that the partially mated state has been reached, the controller manipulates the charging connector 40 to fully mate with the vehicle inlet 50 by applying a predetermined counteracting force. Subsequently, the determines whether a fully mated state has been reached by obtaining information from any locking mechanisms on the charging connector 40 and vehicle inlet 50. If the fully mated state is not confirmed, corrective actions are executed.

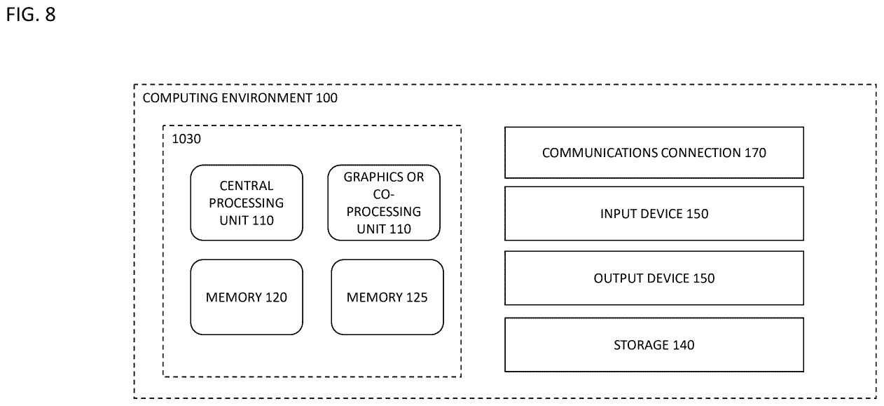

With reference to FIG. 8, the computing environment 100 includes one or more processing units 110, 115 and memory 120, 125. In FIG. 8, this basic configuration 1030 is included within a dashed line. The processing units 110, 115 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 8 shows a central processing unit 110 as well as a graphics processing unit or co-processing unit 115. The tangible memory 120, 125 may be volatile memory (e.g., registers, cache, RAM), non-volatile memory (e.g., ROM, EEPROM, flash memory, etc.), or some combination of the two, accessible by the processing unit(s). The memory 120, 125 stores software 180 implementing one or more innovations described herein, in the form of computer-executable instructions suitable for execution by the processing unit(s).

A computing system may have additional optional features. For example, the computing environment 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The tangible storage 140 may be removable or non-removable, and includes magnetic disks, magnetic tapes or cassettes, CD-ROMs, DVDs, or any other medium which can be used to store information in a non-transitory way and which can be accessed within the computing environment 100. The storage 140 stores instructions for the software 1080 implementing one or more innovations described herein.

The input device(s) 150 may be a touch input device such as a keyboard, mouse, pen, or trackball, a voice input device, a scanning device, or another device that provides input to the computing environment 100. The output device(s) 160 may be a display, printer, speaker, CD-writer, or another device that provides output from the computing environment 100.

The communication connection(s) 170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The described method steps may be performed in sequences different from those shown, including concurrently, unless explicitly stated otherwise. Figures may simplify or omit alternate use cases for clarity.

Any embodiment disclosed herein may be implemented as computer-executable instructions stored on one or more computer-readable media (e.g., flash memory, hard drives, RAM) and executed on computing devices such as smartphones, embedded systems, or cloud-based servers.

The implementation is not limited to specific programming languages or hardware platforms. Code may be written in C++, Java, Python, or other languages and executed on commercially available or custom hardware.

Alternatively, some or all functions may be implemented using hardware logic components such as FPGAs, ASICs, ASSPs, SOCs, or CPLDs.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

For clarity, only selected aspects of software implementations are described, and well-known details are omitted. The disclosed technology is not limited to specific programming languages or hardware. Terms like “configured to” or “able to” encompass components in active, inactive, or standby states, unless otherwise specified. The terms “comprising,” “including,” and “having” are used inclusively and do not exclude additional elements. “Or” is inclusive, meaning one, some, or all items in a list. The articles “a,” “an,” and “the” mean “one or more” unless specified otherwise. “At least one of” or “and/or” refers to any combination of listed items. The term “allow” includes permitting, instructing, enabling, or facilitating a specified action. The detailed description is illustrative, and variations that do not depart from the essence of the claimed invention are within its scope.

1. Method for controlling an autonomous charging device (ACD) configured to manipulate an electric vehicle charging connector for mating into a vehicle inlet, the vehicle charging connector and the vehicle inlet configured to transition between at least an unmated state, a partially mated state and a fully mated state, wherein the partially mated state comprises a partial insertion of the charging connector into a cavity of the vehicle inlet and wherein the fully mated state comprises a state wherein a transfer of energy is allowed,
the method comprising, by a controller, at least the following steps:
(a) manipulating the charging connector towards the vehicle inlet and determining, whether the charging connector and the vehicle inlet have reached the partially mated state; and
(b) if the determination indicates that the charging connector and the vehicle inlet are in the partially mated state, manipulating the charging connector to move to the fully mated state.

2. The method in accordance with claim 1, wherein the step of determining whether the partially mated state has been reached comprises detecting a predefined condition indicating partial mating.

3. The method in accordance with claim 1, wherein the controller is configured to apply a different force pattern when the connector and the vehicle inlet are in the partially mated state than when the connector and the vehicle inlet are in the unmated state.

4. The method in accordance with claim 2, wherein the controller is configured to manipulate the charging connector by applying a counteracting force (f1) higher than a counteracting force limit (f2) applied prior to the partial mating when transitioning from the partially mated state to the fully mated state, wherein a ratio of the counteracting force (f1) to the counteracting force (f2) limit is about 6:1, or about 4:1, or about 2:1.

5. The method in accordance with claim 1, wherein the controller is configured to apply a force reduction strategy while transitioning from the partially mated state to the fully mated state.

6. The method in accordance with claim 1, wherein determination of the partially mated state comprises determining a connection state between the charging connector and the vehicle inlet by receiving information comprising a detection signal of at least one of a charging connector or charging inlet communication pin, a power pin or a proximity pin, wherein such information is received from at least one of the charging connector, the vehicle, a charger or a charging station management system.

7. The method in accordance with claim 6, wherein determination of the partially mated state comprises determining if the detection signal is above a predetermined detection signal threshold and determining that the partially mated state has been reached when such detection signal is above the detection signal threshold.

8. The method in accordance with claim 1, wherein determination of the partially mated state comprises receiving a sensor signal from a sensor in communication with the ACD, wherein such sensor signal includes at least one of an image sensor, a proximity sensor, and a force sensor.

9. The method in accordance with claim 1, wherein if the determination indicates that the partial mated state has not been reached, the method comprises:
manipulating the charging connector by applying a corrective motion, wherein such corrective motion comprises at least one of a vibrating motion, adjusting a position or orientation of the charging connector, or retracting the charging connector and reattempting to reach the partially mated state; and
optionally determining, prior to an energy transfer, whether a partially mated state of the charging connector and the vehicle inlet is reached.

10. The method in accordance with claim 1, wherein if the determination of the partially mated state is not reached, the method comprises:
activating a warning device, in particular an audible warning device or a visual warning device, prior to manipulating the charging connector toward the fully mated stated into the vehicle inlet.

11. The method in accordance with claim 10, wherein the step of activating the warning device and the subsequent manipulation of the charging connector toward the fully mated state are carried out only when a visual pose determination of the vehicle inlet has been previously made by the autonomous charging device, and the pose has been determined with at least a predetermined minimum level of confidence.

12. The method in accordance with claim 1, further comprising, after manipulating the charging connector to move to the fully mated state,
(c) determining whether the fully mated state is reached.

13. The method in accordance with claim 12 wherein determining whether the fully mated state is reached comprises:
receiving information about a vehicle inlet locking device, wherein such locking device is configured to be switchable between a locked state in which the connector connected to the inlet cannot be detached from the inlet and a non-locked state in which the connector connected to the inlet can be detached from the inlet; and
wherein the fully mated state is determined to be reached when the locking device is in the locked state.

14. The method in accordance with claim 12, wherein determining whether a fully mated state is reached comprises receiving a signal about the vehicle indicating that a transfer is allowed or that a transfer of energy has started or may start.

15. The method in accordance with claim 1, further comprising, generating a signal to be received by the vehicle, the signal comprising an instruction to switch the inlet locking device from the non-locked state to the locked state after the fully mated state of the charging connector and the vehicle is reached,
wherein if the determination indicates that the fully mated state is not reached, the method comprises manipulating the charging connector by applying a corrective motion, wherein such corrective motion comprises at least one of a vibrating motion, adjusting a positioning angle, and retracting the charging connector and reattempting the full mating.

16. The method in accordance with claim 1, wherein the partially mated state comprises the establishment of a connection between a charging connector pin and vehicle inlet pin, the pin selected from the group comprising communication pin, a power pin or a proximity pin.

17. The method in accordance with claim 1, wherein the fully mated state comprises a condition where the charging connector is mechanically engaged with the vehicle inlet and wherein the energy transfer can be initiated.

18. A system for controlling an autonomous charging device (ACD), the ACD configured to manipulate an electric vehicle charging connector for mating into a vehicle inlet, the vehicle charging connector and the vehicle inlet configured to transition between at least an unmated state, a partially mated state and a fully mated state, the system comprising:
a manipulator configured to manipulate the charging connector; and
a controller configured to carry out the steps according to claim 1.

19. An autonomous charging device comprising a system according to claim 18.
